(19) United States
(12) Patent Application Publication
(10) Pub. No.: US 2008/0257689 A1
(43) Pub. Date: Oct. 23, 2008

(54) APPARATUS FOR CONVEYING AND DEDUSTING OF TABLETS OR SIMILAR PELLETS FROM A TABLET PRESS

(75) Inventor: Harald Romer, Reinbek (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Fette GmbH, Schwarzenbek (DE)

(21) Appl. No.: 12/061,927

(22) Filed: Apr. 3, 2008

(30) Foreign Application Priority Data
Apr. 4, 2007 (DE) 10 2007 016 225.3

(51) Int. Cl. B65G 33/00

(52) U.S. Cl. 198/657

(57) ABSTRACT

An apparatus for conveying and dedusting of tablets or like pellets from a tablet press, with a vertically arranged vibration-screw conveyor, which has a lower inlet and an upper outlet, where the screw conveyor has at least two screw channels, to which, in each case, an inlet and an outlet are assigned.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

From DE 94 06 712 U1, the entire contents of which is incorporated herein by reference, an apparatus is known for the deburring and dedusting of tablets. The tablets coming from the outlet of a tablet press are conveyed using a vertical conveyor in the form of a conveyor spiral to a cyclone, in which the dedusting takes place. From the cyclone, the dedusted and deburred tablets reach a receptacle. The surface of the spiral is roughened such that the tablets are conveyed upwards.

In U.S. Pat. No. 7,325,672, the entire contents of which is incorporated herein by reference, a vertical conveyor apparatus is described in which the spiral is led around a central post, and which has a lower inlet and an upper outlet. Here too, the spiral serves for deburring and dedusting. The screw conveyor apparatus can be vibrated.

The objective of the invention is to design such a conveyor and dedusting means that can significantly increase the production volume.

### BRIEF SUMMARY OF THE INVENTION

With the apparatus according to the invention, the screw conveyor has at least two screw channels, each of which is assigned an inlet and an outlet. With use of such an apparatus, for example, two outlets of a double rotary press can be served in order to debur and dedust the delivered tablets, and to transport them to a receptacle.

It is known, to test the tablets for metallic components before packing. Therefore, a configuration of the invention provides that the outlets of the screw conveyor are connected to parallel conveyor channels, which are led through a metal detector.

### BRIEF DESCRIPTION OF THE SEVERAL VIEWS OF THE DRAWINGS

The invention is explained in more detail in the following using drawings.

FIG. 1: shows a side view schematic of a screw conveyor according to the invention.

FIG. 2: shows a top view of the screw conveyor according to FIG. 1.

FIG. 3: shows the connection of the screw conveyor, according to the FIGS. 1 and 2, to a metal detector.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

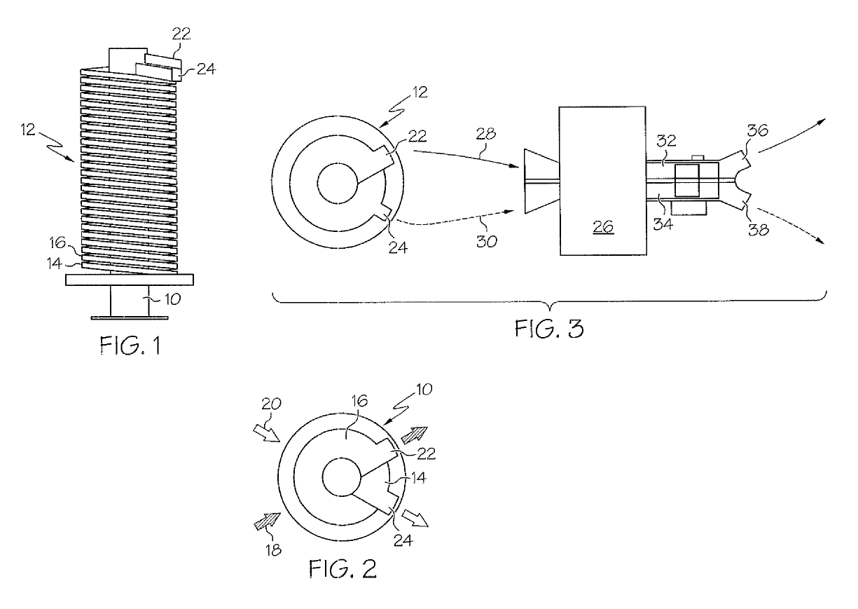

In FIG. 1 a vertical post 10 can be seen, about which a screw 12 spirals with two screw channels 14, 16. The post 10 is located upon a vibration apparatus, not shown, with which the screw 12 can be vibrated. The screw channels 14, 16 are designed groove-like. Due to the vibration, goods (pellets from a rotary press) received in the grooves can be conveyed upwards. In the present case, these are tablets. The inlet to the screw channels 14, 16 occurs at 18 and 20, respectively, in FIG. 2. The inlets 18, 20 are connected to a rotary press, not shown, which has two outlets. Therefore, in each case, an outlet is connected to an inlet 18, 20 of the screw 12. The screw channels 14, 16 end at the upper end of the screw 12 in groove sections 22 and 24, respectively, which form the outlets.

FIG. 3 shows how such a screw conveyor 12 is arranged in front of a metal detector 26. The outlets 22, 24 are connected to associated inlets of the metal detector 26 via groove sections, as indicated by the arrows 28, 30. Parallel conveyor grooves 32, 34 extend through the metal detector 26, where the metal detector 26 tests the tablets for metallic components. The grooves 32, 34 lead to outlets 36, 38, from which, receptacles, not shown, are filled.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. An apparatus for conveying and dedusting of tablets or like pellets from a tablet press, with a vertically arranged vibration-screw conveyor, which has a lower inlet and an upper outlet, characterized in that the screw conveyor (12) has at least two screw channels (14, 16), to which, in each case, an inlet (18, 20) and an outlet (22, 24) are assigned.

2. The apparatus according to claim 1, characterized in that the upper outlets (22, 24) have groove sections.

3. The apparatus according to claim 1, characterized in that the tablet press has two outlets, which are connected via outlet channels to the inlets (18, 20) of the screw conveyor (12).

4. The apparatus according to claim 3, characterized in that the outlets (22, 24) of the screw conveyor are connected to parallel conveyor channels (32, 34), which are led in parallel through a metal detector (26).
